(19) United States
(12) Patent Application Publication
(10) Pub. No.: US 2011/0307394 A1
(43) Pub. Date: Dec. 15, 2011

(54) Municipal bicycle sharing system

(76) Inventor: S. Ryan Rzepecki, Wattsburg, PA (US)

(21) Appl. No.: 12/456,227

(22) Filed: Jun. 12, 2009

(51) Int. Cl. G06Q 30/00

(52) U.S. Cl. 705/307; 705/13

(57) ABSTRACT

A bike share system with the flexibility to anchor the rental bike anywhere at the end of the trip employs a remotely operable lockbox which incorporates a wireless communication card with a GPS receiver. The bike itself has a battery for operating the wireless communication card and the GPS receiver and a hub dynamo for recharging the battery while the vehicle is in motion. A method of operating a stationless bicycle rental business is also disclosed. The remote lock can be disengaged by sending a text message, a voice message, a smart card message, or inputting required information using a keypad on the lockbox.

### BACKGROUND AND SUMMARY OF THE INVENTION

The present invention is directed to the field of transportation. More particularly, the present invention is directed to a stationless bicycle sharing system and method of conducting such a business from a remote location.

The sustainability movement has spawned the growth of bicycle rental operations as a means of improving mobility and reducing automobile dependency. The systems proposed thus far typically include locking stations and rental kiosks where credit card payment can be made. The requirement of such features limits the growth of the business because land acquisition and the installation of expensive infrastructure are required. These restrictions cause problems for users of the system because bicycles must be returned to a limited number of pre-determined locations.

The present invention removes these down-sides from a bicycle sharing system by allowing the rented vehicle to be chained to any authorized object such as a light post, a telephone pole, a guardrail, or the like. The bicycles themselves will be distinctive in design and color and the lockbox will feature an illuminated status screen. When the lock is engaged and the transaction is complete, the status will display “Available”. When the bike is placed on temporary hold by the user to run into a store, for example, the status screen will display “Hold.” When the bike is in need of repair, the status will display “Repair.” Finally, if a bike is improperly parked and flagged for removal by, for example, a police officer, the status will display “Relocate”.

Additional features of the bicycle sharing system of the present invention include the capability to unlock the bicycle from a remote location by using a wireless communication device secured within a lockbox, making the use of kiosks or stands unnecessary. The lockbox will also include a global positioning system (GPS) tracking unit that tracks the real time position of each bike. The GPS receiver and wireless device will be powered by onboard battery(ies) that is/are recharged by a dynamic recharging means such as, for example, a bicycle hub dynamo that recharges the battery(ies) while the bicycle is in motion. The GPS/wireless communication system allows a computer-based, central monitoring and control system to track the position of each bicycle in the system, collect trip data for use by the system administrators and end users, and transmit unlock commands to the manually locked/remotely unlocked locking system on the bicycle when a valid request is received from a potential customer. This electronic locator system should also reduce/eliminate pilfering of bicycles utilized in the system.

The present invention comprises a stationless bike share system for use in municipalities which includes a) a plurality of bicycles, each bicycle of the plurality having a locking system including a lockbox, each lockbox including a GPS tracking system and a wireless communication device, each lockbox functioning as a bicycle securing means to retain a bicycle to a stationary object against unauthorized removal, each lockbox including locking means which is manually locked and remotely unlocked; b) battery means for powering the GPS tracking system and the wireless communication device; c) a remote monitoring system for determining location of each of the bikes, authorizing use by remotely unlocking the locking means upon receipt of a confirmed request. The system further includes an internal hub dynamo to recharge the battery means while the bicycle is in motion. The locking system further includes a U-shaped locking member and chain, the lockbox having a plurality of recesses, each of the plurality of recesses designed to receive and secure an arm of said U-shaped locking member when the arm is manually inserted therein. The system, more specifically, the lockbox, includes a keypad.

Preferably, the lockbox can be unlocked by a remote signal in response to at least one of four inputs: a) an authorized text “Unlock” message; b) a cell phone request where a user provides proper responsive information; c) a smartphone application request; and, d) direct entry of account number and authorization code into the keypad. More preferably, the lockbox can be unlocked by a remote signal responsive to at least two of the four inputs, and most preferably, to any of these four inputs The keypad further has buttons which include a “Hold” button to allow retention of control of said bicycle for a limited period, a “Repair” button transmitting a signal to said remote monitoring system advising that the bicycle is in need of service, and “Relocate” advising the remote monitoring system of a need to move the bicycle to an alternate location. It is desired that law enforcement personnel will have the means to activate the “Relocate” button. The keypad further includes an “Available” light which illuminates when the arms of said U-shaped lock are manually inserted in the plurality of recesses without one of said auxiliary buttons being depressed.

The invention further includes a method of conducting a stationless bicycle rental business, the method comprising the steps of a) equipping a plurality of bicycles each with i) a GPS tracking system; ii) a wireless communication device; iii) a battery to power the GPS tracking system and the wireless communication device; iv) a lockbox containing the GPS tracking system and the wireless communication device, as well as a remotely operable lock; b) establishing a central monitoring and control system on a remote computer; c) determining a particular real-time position for a particular bicycle; d) transmitting the real-time position to the central monitoring and control system; e) receiving a signal from a prospective customer in proximity to the particular bicycle at the central monitoring and control system; f) storing bits of information contained in the received signal in the database of the computer; g) comparing said stored bits to information contained in said database; h) if the stored bits do not match existing data in the stored bank, establishing a new account for the prospective customer then proceeding to the next step, and if the stored bits do match existing data in the stored bank, proceeding to the next step; j) sending a signal to said remotely operable lock unlocking the lock allowing use of the bicycle by the prospective customer. An additional method step of equipping the bicycle with a dynamic means to recharge said battery during movement of the bicycle is contemplated. The unlocking method step is performed in conjunction with the receipt by the central monitoring and controlling computer of a signal selected from a group consisting of a) an authorized text “Unlock” message; b) a cell phone request where a user provides proper responsive information; c) a smartphone application request; and, d) direct entry of account number and authorization code into the keypad. Various other features, advantages, and characteristics of the present invention will become apparent after a reading of the following detailed description.

### BRIEF DESCRIPTION OF THE DRAWINGS

The preferred embodiment(s) of the present invention is/are described in conjunction with the associated drawings in which like features are indicated with like reference numerals and in which

FIG. 1a is a schematic side view of a first embodiment of the bicycle utilized in the stationless bicycle sharing system of the present invention;

FIG. 1b is a schematic front view of a lockbox used in conjunction with the first embodiment of the present invention;

FIG. 1c is a schematic rear view of the lockbox shown in FIG. 1B;

FIG. 2 is a schematic depiction of the various component elements of the municipal bike sharing system of the present invention;

FIG. 3a is a logic flow chart employed by the activation computer for unlocking responsive to a text entry;

FIG. 3b is a logic flow chart employed responsive to an automated phone call;

FIG. 3c is a logic flow chart employed responsive to smartphone application request; and,

FIG. 3d is a logic flow chart employed responsive to manual keypad entry.

### DETAILED DESCRIPTION OF THE PREFERRED EMBODIMENT(S)

The two critical features of the stationless bicycle share system of the present invention are 1) an effective locking mechanism and, 2) the electronics package including the battery-powered GPS unit and the wireless communication device, the battery(ies) being recharged by a dynamic recharger such as an internal hub dynamo mounted on one of the wheels.

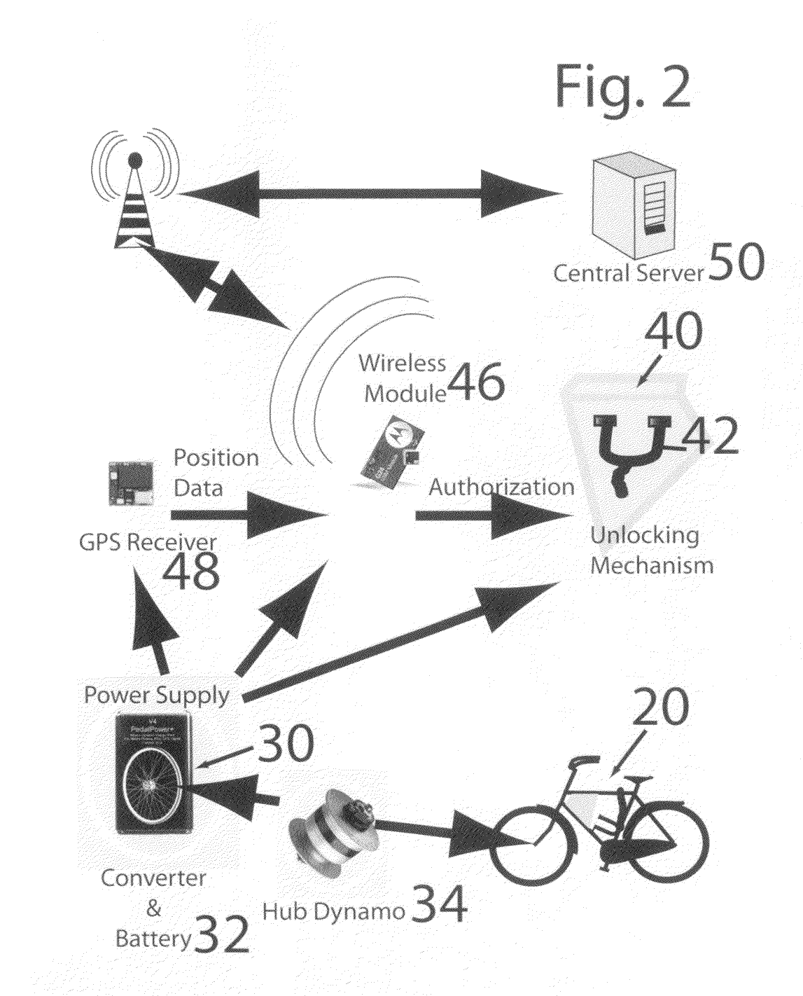

As depicted in FIG. 2, the components of the bike share system include a rugged, reliable bicycle 20, a rechargeable power supply 30 system including a converter and battery 32, a hub dynamo 34. One suitable bike is available from Worksman Cycles of New York City, N.Y., manufacturers of sturdy industrial cycles for over a century. It is preferred that the bicycle be painted with a retro-reflective powder coating of the type commercially available from Halo Coatings, a subsidiary of MKB LLC of Port Clinton, Ohio, under the trademark “Hi-Viz”. It is desired that the cycles used in the cycle share system to be marketed under the trademark “MuniBike”, be easily identifiable by the color and color scheme utilized such as “taxicab yellow”, for example. The hub dynamo 34 can be of the “V4” type available from PedalPower+ along with the connector cable and converter utilized to charge a lithium ion battery 32.

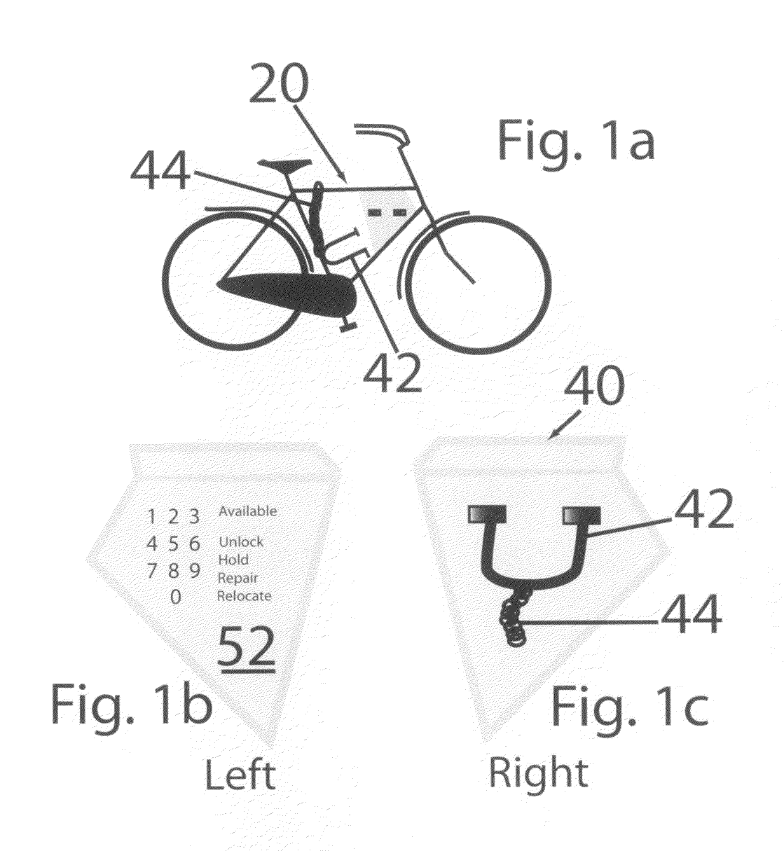

Each bicycle 20 is equipped with a lockbox 40 with a remotely operable locking mechanism which receives a U-shaped lock engaging device 42 which is attached to the end of bicycle securing chain 44. The chain 44 can be wrapped around a lamppost or guardrail to secure the bicycle 20 when the user's journey is completed. Suitable remotely actuatable locks are manufactured by Stanley Security Solutions of Indianapolis, Ind. Within the lockbox 40 will be a wireless module 46 with a separate or associated GPS receiver 48. One suitable system is a Motorola M2M card with an integrated GPS receiver which can offer a range of solutions for several different networks. The wireless communication card/GPS receiver is powered by battery 32. Preferably, on the side of the lockbox 40 opposite the lock insertion point (FIG. 1C), is a keypad 52 with a series of illuminatable messages including “Available”, “Unlock”, “Hold”, “Repair”, and “Relocate” (FIG. 1B).

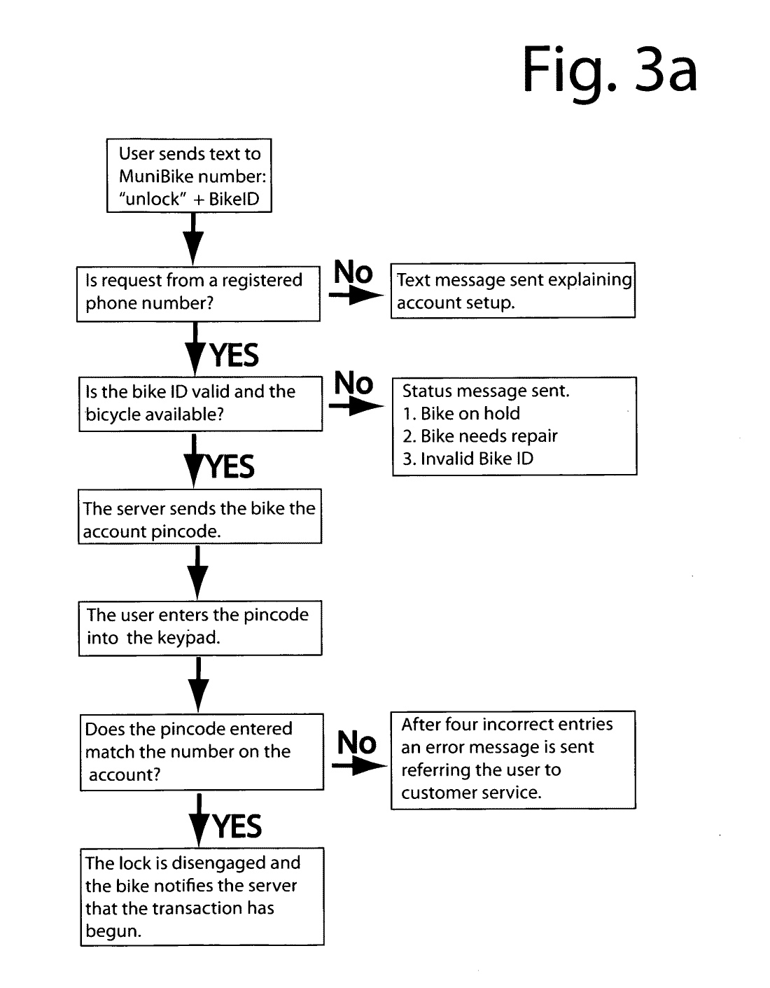

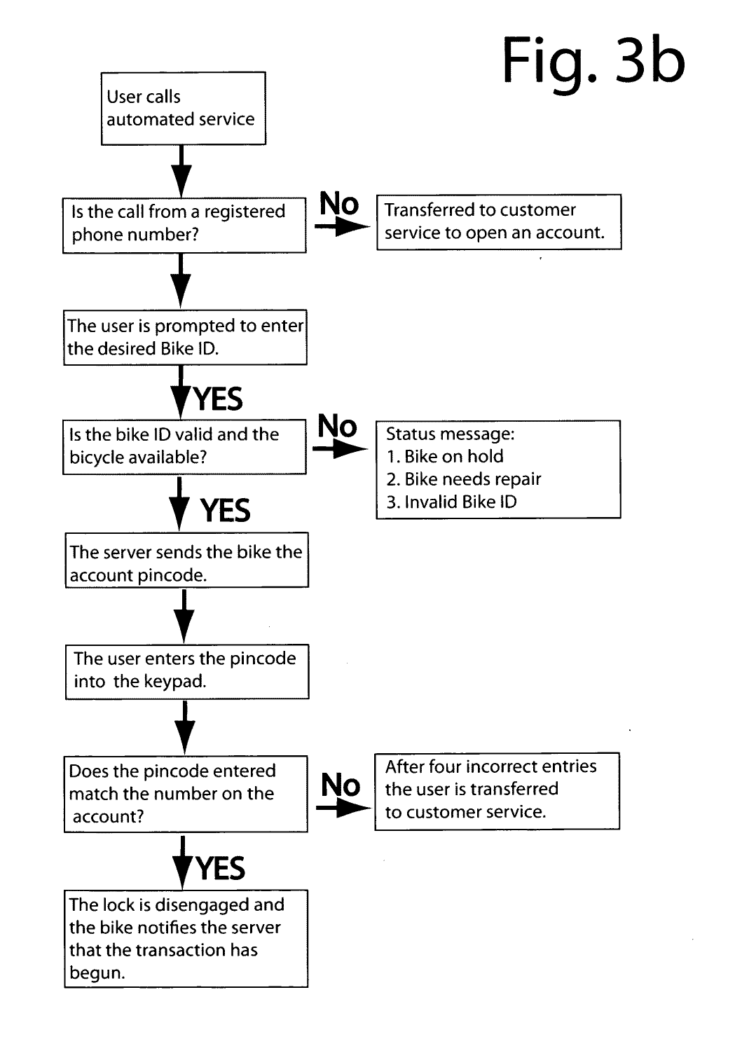

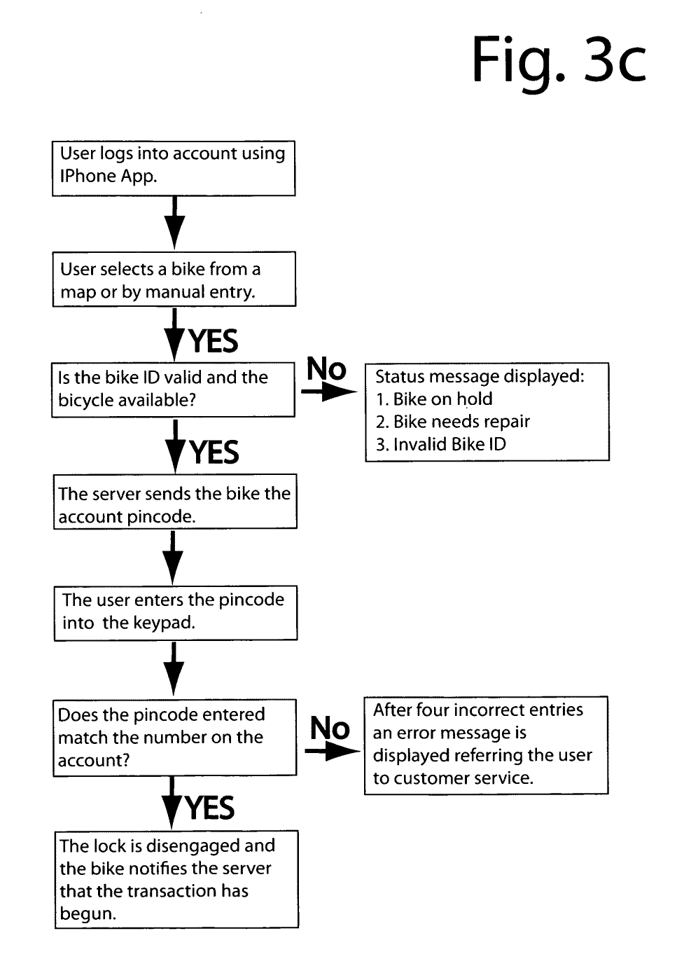

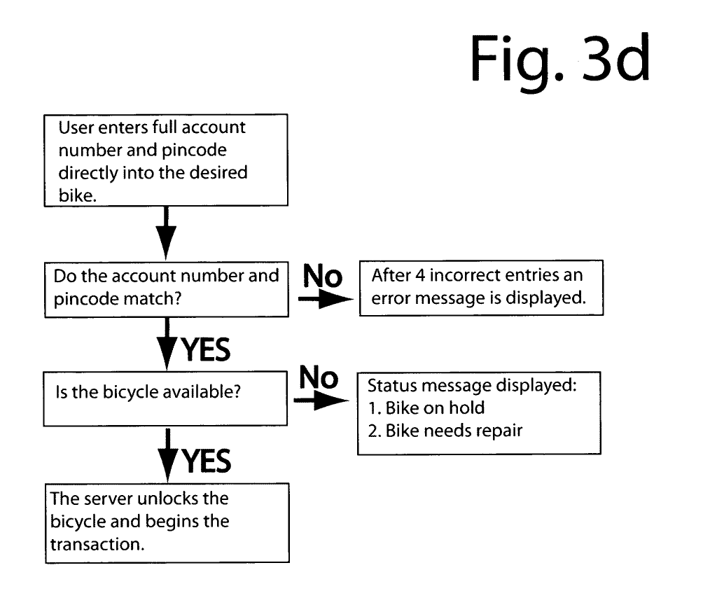

A central server 50 (FIG. 2) processes rental requests received by one of a number of means: 1) cell phone text, 2) automated phone call; 3) a smartphone application; and, 4) direct entry of the account number and authorization code into the keypad 52. The logic sequence for a texted message is depicted in FIG. 3a. Before sending a text request a user must be registered with the system, otherwise they will receive an error message. Once registered, a user will text his unlock request along with the Bike ID to the MuniBike contact number. A monitoring and control system will be set up on the central server 50. The central server 50 will compare the phone number from which the request is made to its database to verify that the number is attached to an active account. If there is no corresponding number in the database, the server 50 sends a text message advising the potential user steps which need to be taken to set up an account. If the information matches a registered phone number, the central server then verifies that the bike ID is valid and that the bike is available. If the bike is available, the central server 50 sends the user's account pincode to the wireless module 46. The prospective user enters her/his pincode using the keypad 52 and when it matches the code sent from the server, the lock is disengaged and the lockbox 40 notifies the central server 50 that the rental transaction has begun.

FIG. 3b depicts the logic sequence followed by the central server 50 for an automated phone call. When the call comes in, the server compares the originating number to numbers stored in the database. If there is no match, the potential user is transferred to customer service to allow an account to be set up. If there is a match, the automated call prompts the potential user to input the bike ID either verbally or using the keys of the phone. If the bike is not available, a voice message will explain the reason. If the bike is available, the server 50 again sends the pincode to the bike, where the potential user inputs her/his code using the keypad to initiate the rental session.

Smartphone application access is depicted in FIG. 3c. The potential user logs in using a smartphone application. S/he may then select a bike from a display map showing the positions of all available bikes in the system or by entering a bike ID manually. The central server 50 compares the bike ID to the information stored in its database. If the bike is unavailable, an error message is displayed on the phone's screen.40. If the bike is available, the user's pincode is transmitted to the lockbox 46 and if the user enters the correct code, the lock is disengaged and the server 50 is notified that the rental session has begun.

FIG. 3d depicts the logic steps employed when the potential user inputs her/his request using the keypad 52. The user inputs his account number (generally her/his telephone number) and pincode directly into the keypad. The wireless communication card sends the pincode 46 to the central server 50 which compares the input information to the information stored in its database. If there is a match and, hence, a valid account, the server verifies that the bike is available, as with each of the previous logic methodologies. If the bike is available, the remote unlocking mechanism disengages the U-lock 42 and advises the server 50 that the rental session has begun.

Various changes, alternatives, and modifications will become apparent to a person of ordinary skill in the art after a reading of the foregoing specification. It is intended that all such changes, alternatives, and modifications as fall within the scope of the appended claims be considered part of the present invention.

I claim:

1. A stationless bike share system for use in municipalities, said bike share system comprising
a) a plurality of bicycles, each bicycle of said plurality having a locking system including a lock box, each said lock box including a GPS tracking system and a wireless communication device, each lock box functioning as a bicycle securing means to retain a bicycle to a stationary object against unauthorized removal, each lock box including locking means which is manually locked and remotely unlocked;
b) battery means for powering said GPS tracking system and said wireless communication device;
c) a remote monitoring system for determining location of each of said bikes, authorizing use of a particular one of said plurality of bicycles by remotely unlocking said locking means upon receipt of a confirmed request.

2. The stationless bike share system of claim 1 further comprising an internal hub dynamo to recharge said battery means while said bicycle is in motion.

3. The stationless bike system of claim 1 wherein said locking system further comprises a U-shaped lock and chain, said lock box having a plurality of recesses, each of said plurality of recesses designed to receive and secure an arm of said U-shaped lock when said arm is manually inserted therein.

4. The stationless bike system of claim 3 further comprising a keypad on said lock box.

5. The stationless bike system of claim 4 wherein said lock box can be unlocked by a remote signal in response to at least one of four inputs: a) an authorized text “Unlock” message; b) a cell phone request where a user provides proper responsive information; c) a smart phone application message; and, d) an authorization code input using said keypad.

6. The stationless system of claim 5 wherein said lock box can be unlocked by a remote signal in response to at least two of said four inputs.

7. The stationless bike system of claim 5 wherein said lock box can be unlocked by a remote signal in response to any of said four inputs.

8. The stationless bike system of claim 5 wherein said keypad further comprises auxiliary buttons including “Hold” to allow retention of control of said bicycle for a limited period, “Repair” transmitting a signal to said remote monitoring system advising that said bicycle is in need of service, and “Relocate” advising said remote monitoring system of a need to move said bicycle to an alternate location.

9. The stationless bike system of claim 8 wherein said keypad further comprises an “Available” light which illuminates when said arms of said U-shaped lock are manually inserted in said plurality of recesses without one of said auxiliary buttons being depressed.

10. A method of conducting a stationless bicycle rental business, the method comprising the steps of:
a) equipping a plurality of bicycles each with
I) a GPS tracking system;
ii) a wireless communication device;
iii) a battery to power said GPS tracking system and said wireless communication device;
iv) a lockbox containing said GPS tracking system and said wireless communication device, as well as a remotely operable lock;
b) establishing a central monitoring and control system on a remote computer;
c) determining a particular realtime position for a particular bicycle;
d) transmitting said realtime position to said central monitoring and control system;
e) receiving a signal from a prospective customer in proximity to said particular bicycle at said central monitoring and control system;
f) storing bits of information contained in said received signal in a data bank of said computer;
g) comparing said stored bits to information contained in said data bank;
h) if said stored bits do not match existing data in said stored bank, establishing a new account for said prospective customer then proceeding to the next step, and if said stored bits do match existing data in said stored bank, proceeding to the next step;
j) sending a signal to said remotely operable lock unlocking said lock allowing use of said bicycle by said prospective customer.

11. The method of claim 10 further comprising the step of equipping said bicycle with a dynamic means to recharge said battery during movement of said bicycle.

12. The method of claim 10 wherein said receiving step further comprises receiving a signal from a group consisting of a) a cell or other phone of said prospective customer; b) a smart phone application; and, c) an entry on a keypad associated with said lockbox.
